(19) United States
(12) Patent Application Publication
(10) Pub. No.: US 2007/0144595 A1
(43) Pub. Date: Jun. 28, 2007

(54) HOLLOW PISTON VALVE

(76) Inventor: Dan Geva, Kiryat Bialik (IL)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 11/456,315

(22) Filed: Jul. 10, 2006

(30) Foreign Application Priority Data
Dec. 28, 2005 (IL) 172877

(51) Int. Cl. F16K 11/07

(52) U.S. Cl. 137/625.48

(57) ABSTRACT

A modular hollow sliding piston fluid valve, includes at least one inlet port and at least one outlet port both attached to a housing, and an axially-slidable piston inside the housing provided with means to close an inlet port when in proximity thereto, the piston being configured with at least one opening allowing fluid to enter the inner part of the piston from the inlet port and flow through the opposite open portion of the piston and through the outlet port when the piston is moved in proximity to the outlet valve, the housing having provision for the possible addition of a third port disposed at about 90° to the axis of the piston.

The present invention relates to directional flow control of pressurized fluids.

More particularly, the invention provides an improved flow modular valve for fluids which can readily be adapted for two-way or three-way operation, for 90° or straight though flow. Modular construction allows the ready replacement of worn seals and of other components. The valve can also be readily changed for manual operation, mechanical operation, spring operation in one direction and pilot fluid movement in one or two directions.

Valves for fluid control may be globe valves, butterfly valves, spool valves, diaphragm and others. The present invention is however concerned only with sliding hollow piston valves.

Fluid valves of various types have been in extensive use for many decades. While the main applications are hydraulic or pneumatically-operated machinery, valves are also used to control the flow of a product or process, as well as liquids such as fuels, beverages, and water.

Some valve manufacturers design their valves in a modular manner, so that a valve to a desired specification can be assembled from a selection of a small number of parts which are quantity produced. Modular valve systems are known, and seen in the following US Patents:
U.S. Pat. No. 3,989,058 to Jackson et al disclosing a spool valve;
U.S. Pat. No. 4,979,530 to Breda, also a spool valve;
U.S. Pat. No. 5,111,840 to Miller et al., again a spool valve;
U.S. Pat. No. 5,313,985 to Donner, a complex solenoid operated valve; and
U.S. Pat. No. 5,749,562 to Möller et al., multiple interconnected valves.

The above disclosures do not relate to the sliding piston type valve, which is most advantageous for large flows through a moderately sized valve body. To prevent unnecessary pressure losses a valve should provide as straight a path as possible and a consistent flow area for the fluid flowing therethrough. The sliding piston type valve is the most appropriate for this purpose.

It is therefore one of the objects of the present invention to obviate the disadvantages of prior art valves and to provide a sliding piston valve having low fluid resistance relative to the valve size.

It is a further object of the present invention to provide a modular valve which can easily be converted from a two-way valve to a three-way valve

It is a further object of the present invention to provide a modular valve which can easily be dismantled and re-assembled for maintenance purposes.

The present invention achieves the above objects by providing a modular sliding piston fluid valve, comprising at least one inlet port and at least one outlet port both attached to a housing, and an axially-slidable piston provided with means to close an inlet port when in proximity thereto, the piston being configured with at least one opening allowing fluid to enter the inner part of the piston from the inlet port and flow through the opposite open portion of the piston and through the outlet port when the piston is moved in proximity to the outlet valve, the housing having provision for the possible addition of a third port disposed at about 90° to the axis of the piston.

In a preferred embodiment of the present invention there is provided a sliding piston valve wherein seals are provided in contact with said sliding piston to prevent leakage of compressed gas.

In a further preferred embodiment of the present invention there is provided a valve wherein seals are provided in contact with said sliding piston to prevent leakage of compressed gas.

In another preferred embodiment of the present invention there is provided a valve wherein seals are not provided and said valve is used to control liquid flow.

In a further preferred embodiment of the present invention there is provided a valve wherein said outlet port is a port disposed at about 90° to the axis of said piston, and the opening serving the in-line outlet port is closed by a seal cover irrespective of the piston position, and wherein said third port serves as the outlet port.

In a further preferred embodiment of the present invention there is provided a valve comprising a substantially cylindrical outer housing having two end faces, wherein a first plurality of valve components are axially stacked and attached to a first end face of said housing by a plurality of radially-spaced-apart threaded fasteners and a second plurality of valve components is axially stacked and attached to a second end face of said housing by a further plurality of threaded fasteners.

In yet a further preferred embodiment of the present invention there is provided a valve wherein said piston is provided with a shoulder and a spring is arranged to contact said shoulder to urge said piston in the direction of said inlet port to close same.

In another preferred embodiment of the present invention there is provided a valve wherein said piston is provided with a shoulder and the housing is further provided with at least one additional inlet for pilot pressure fluid to apply pressure to at least one side of said shoulder to move said sliding piston in a desired axial direction.

In another preferred embodiment of the present invention there is provided valve wherein all ports are active to form a three-way valve.

In a further preferred embodiment of the present invention there is provided a valve wherein movement of the piston to be proximate to said inlet port allows fluid flow in either direction between said outlet port and said third port.

In a most preferred embodiment of the present invention there is provided a valve wherein movement of the piston to be proximate to said outlet port causes said piston to block fluid flow through said third port.

In. European Patent no. EP 0 566 543 A1 there is described and claimed a sliding piston two-way valve for pneumatic application. The valve comprises 4 basic components; the main housing including a first port and the pilot control ports, a large diameter screw-in component comprising the second port, a conical deflector and the sliding piston. The large diameter screw thread is likely to become inoperable in the course of valve usage, and is subject to leakage when pilot pressure is applied. The seal elements are difficult to replace. There is no provision for conversion to a three-way valve.

In contradistinction thereto, the present invention is adapted to be used as a three-way valve and as a 90° 2-way or three-way valve. The valve of the present invention comprises several separate but simple components, each of which can be individually replaced at moderate cost. No large diameter screw thread is needed. The fasteners used for assembly are low cost off-the-shelf screws. A hydraulic version of the valve is provided.

It will thus be realized that the novel valve of the present invention serves to overcome the drawbacks of prior art valves. The valve is easily maintained, and when in use provides low flow resistance. Uses of the valve are many, because configuration changes are easily effected by changing some of the components.

The invention will now be described further with reference to the accompanying drawings, which represent by example preferred embodiments of the invention. Structural details are shown only as far as necessary for a fundamental understanding thereof. The described examples, together with the drawings, will make apparent to those skilled in the art how further forms of the invention may be realized.

### IN THE DRAWINGS

FIG. 1 is a sectioned elevational view of a preferred embodiment of the valve according to the invention;

FIG. 2 is a sectioned elevational view of a detail of the valve;

FIG. 3 is a sectioned elevational view of an embodiment intended for hydraulic service;

FIG. 4 is a sectioned elevational view of a 90° valve intended for pneumatic service;

FIG. 5 is a sectioned elevational view of a pneumatic three-way valve showing the modular arrangement of the assembly;

FIG. 6 is a sectioned elevational view of a three-way valve pressure operated spring return; and

FIG. 7 is a sectioned elevational view of a hydraulic three-way valve.

FIG. 8 is a sectioned elevational view of an embodiment of the inlet part.

FIG. 9 is a sectioned elevational view of a further embodiment of the inlet part.

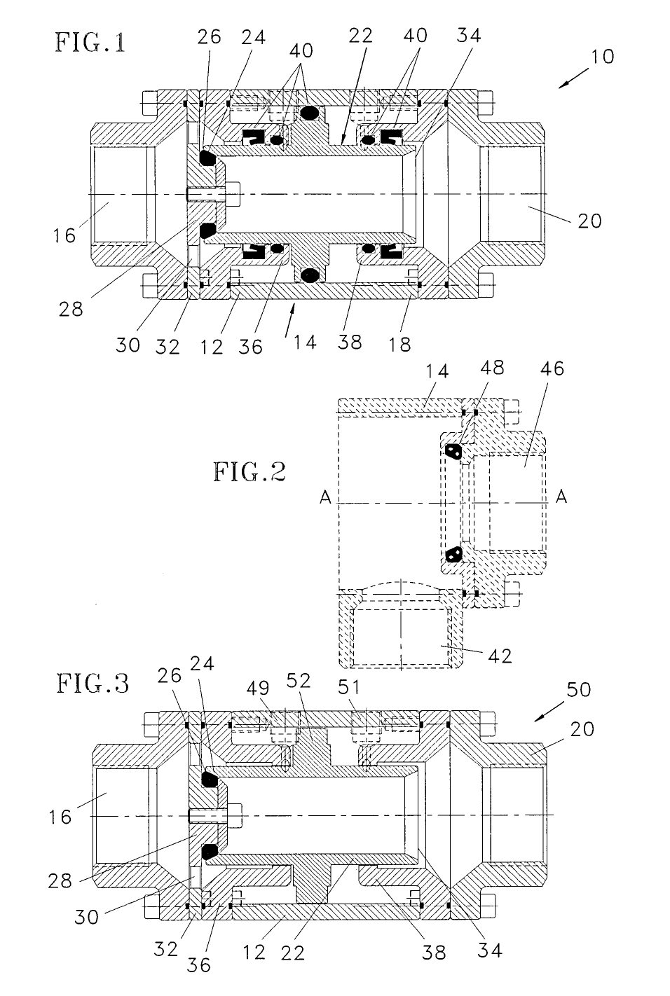

There is seen in FIGS. 1 and 2 a modular, sliding-piston, pneumatic two-way valve 10. Attached to the left end 12 of the valve housing 14 is an inlet port 16. At a right end 18 of the housing 14 there is attached an outlet port 20.

An axially-slidable piston 22 is provided with a chamfered inner edge 24 which presses against the seal 26 of a central boss 28 when said piston 22 is in its left position as seen in the diagram. As is seen in the diagram the inlet valve is closed when the chamfered edge 24 is pressed against the seal 26.

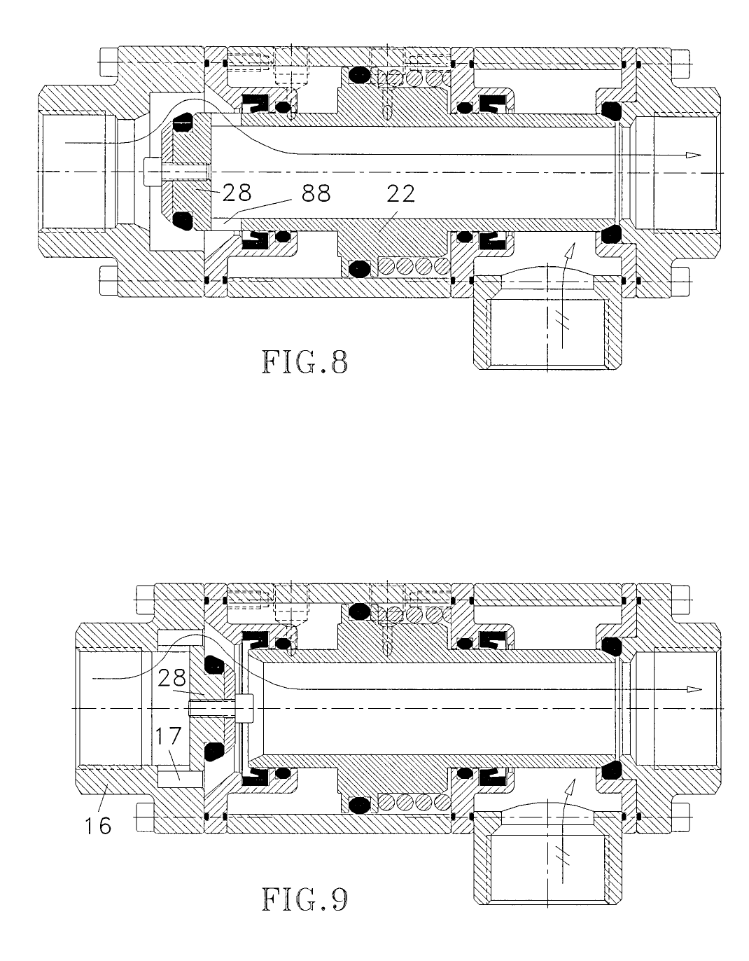

Said central boss 28 is either part of disc 32 or as seem in FIG. 1 being connected to piston 22 as illustrated in FIG. 8 or connected to inlet 16 or integral therewith as illustrated in FIG. 9.

The piston 22 seen in the present embodiment is fully open at both of its extremities. Thus when the piston 22 is moved towards the outlet port 20, as will be seen for example in FIG. 5, fluid from the inlet port 16 flows freely through apertures 30 seen piercing the disc 32 supporting the central boss 28. Next the fluid passes between the central boss seal 26 and the piston chamfered edge 24. Fluid enters the inner part of the piston 22 and flows through the opposite open end 34 thereof and through the outlet port 20.

The figure also shows a left stop flange 36 and a right stop flange 38, both of which are utilized to carry seal elements 40. The various seals 40 are provided to contact external faces of the sliding piston 22 to prevent leakage of air when the valve 10 is used as part of a pneumatic circuit.

As seen in FIG. 2, the housing 14 has provision for the possible addition of a third port 42 disposed at about 90° to the axis AA of the sliding piston 22. The housing aperture 44 accommodating third port 42 is closed by a suitable plug or cover (not seen) when the third port is not used, as in the present embodiment.

The outlet port 46 and the seal 48 will be described with reference to FIG. 7.

With reference to the rest of the figures, similar reference numerals have been used to identify similar parts.

FIG. 3 illustrates a modular two-way hydraulic valve 50 seen in its closed position. With the exception of the seal 26, seals are not provided. In other respects the valve is similar to the valve 10 described with reference to FIG. 1.

Inlet ports 49, 51 for pilot pressure are provided. Pilot hydraulic pressure can thus act upon either side of the shoulder 52 attached to the sliding piston 22. Hydraulic actuation of valves is particularly useful for automatic operation of large valves.

The elimination of seals subjected to the high pressures typical in hydraulic applications simplifies both design and construction and reduces costs. Due to the higher viscosity of fluids, metal to metal sealing is adequate to prevent leakage, and thus most seals are eliminated.

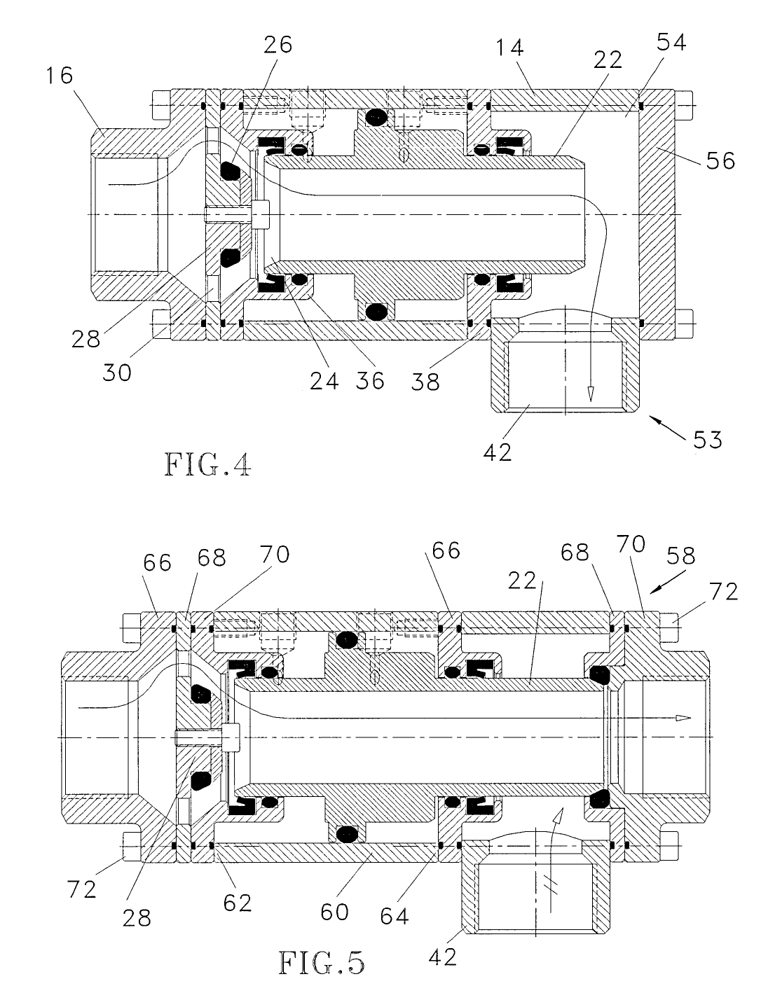

Seen in FIG. 4 is a modular pneumatic two-way 90° valve 53 shown in its open (piston at right side) position. The outlet port is the third port 42 disposed at 90° to the axis of the piston 22. Fluid (air) flows is the same manner as described with reference to FIG. 1, except that the third port 42 functions as the outlet port.

Moving the piston 22 towards the left brings the chamfered inner edge 24 into contact with the seal 26 of the central boss 28 to seal the inlet port 16 and stop flow.

With regard to the large opening 54 remaining after the outlet port 20 seen in FIG. 1 is removed, a thick disk cover 56 is rigidly attached to the housing 14 to seal opening 54. However if it is preferred to leave the outlet port 20 in place, the port can easily be plugged and sealed.

In either case, all fluid entering the valve 53 must leave via the third port 42.

Referring now to FIG. 5, there is depicted a modular pneumatic three-way valve 58 comprising a substantially cylindrical outer housing 60 having two end faces 62, 64. At least three valve components, numbered 66, 68, 70 irrespective of their form, are axially stacked and attached to each end face 62, 64 of the housing 60 by a plurality of spaced-apart threaded fasteners 72, preferably corrosion-protected hexagon socket cap screws. Thus when it becomes necessary to replace any of the seals or other components the valve is easily dismantled and reassembled.

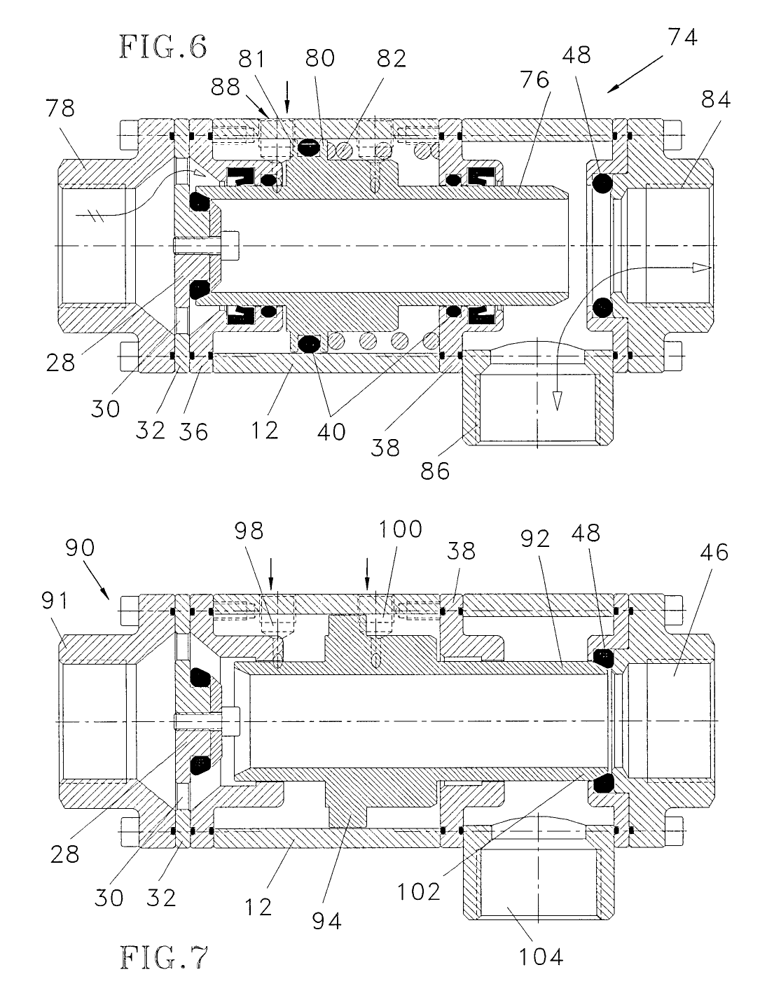

FIG. 6 shows a three-way pneumatic valve 74 wherein the sliding piston 76 is seen in its left position and has closed the inlet port 78. The sliding piston 76 is provided with a shoulder 80. A compression spring 82 is arranged to contact the shoulder 80, and as seen in the figure the spring 82 has moved the piston 76 in the left direction towards the inlet port 78 to close same. This movement of the piston 76 allows fluid flow in either direction between the outlet port 84 and the third port 86.

The inlet port 78 is opened by admitting pilot pneumatic pressure through port 88. Air pilot pressure on the shoulder 81 overcomes the resistance of the compression spring 82 and moves the piston towards the right to contact the seal 48 to seal port 86. Release of pilot air pressure allows the spring 82 to return the piston 76 to its original position.

FIG. 7 illustrates a three-way modular hydraulic valve 90 seen in its open-inlet position, wherein fluid flows from the inlet port 91 through the piston 92 to exit via the port 46. The sliding piston 92 is provided with a shoulder 94. The housing 96 is further provided with two additional inlets 98, 100 for hydraulic pilot pressure to be applied to either side of the shoulder 94 and so to move the sliding piston 92 in a desired axial direction.

While opening the inlet port 91 by moving in a rightward direction the piston 92, being provided with an external chamfer 102, presses against the seal 48 to prevent leakage of fluid (hydraulic oil) flowing through the piston 92 and out through the port 46. Simultaneously the piston 92 seals the third port 104.

FIG. 8 illustrates a further embodiment when the central boss 28 is connected to piston 22. The fluid flows through apparatus 88 provided at one end of piston 22.

FIG. 9 illustrates yet a further embodiment when the central boss 28 is connected or integral with port 16. The fluid flows through opening 17.

The scope of the described invention is intended to include all embodiments coming within the meaning of the following claims. The foregoing examples illustrate useful forms of the invention, but are not to be considered as limiting its scope, as those skilled in the art will be aware that additional variants and modifications of the invention can readily be formulated without departing from the meaning of the following claims.

1. A modular hollow sliding piston fluid valve, comprising at least one inlet port and at least one outlet port both attached to a housing, and an axially-slidable piston inside said housing provided with means to close an inlet port when in proximity thereto, said piston being configured with at least one opening allowing fluid to enter the inner part of said piston from said inlet port and flow through the opposite open portion of said piston and through said outlet port when said piston is moved in proximity to said outlet valve, said housing having provision for the possible addition of a third port disposed at about 90° to the axis of said piston.

2. The valve as claimed in claim 1, wherein seals are provided in contact with said sliding piston to prevent leakage of fluids and at both ends of said housing.

3. The valve as claimed in claim 1, wherein seals are not provided to the sliding piston and said valve is used to control liquid flow.

4. The valve as claimed in claim 1, wherein said outlet port is a port disposed at about 90° to the axis of said piston, and the opening serving the in-line outlet port is closed by a seal cover irrespective of the piston position, and wherein said third port serves as the outlet port.

5. The valve as claimed in claim 1, wherein said piston is provided with a shoulder and a spring is arranged to contact said shoulder to urge said piston in the direction of said inlet or outlet ports to close or open same.

6. The valve as claimed in claim 1, wherein said piston is provided with a shoulder and the housing is further provided with at least one additional inlet for pilot pressure fluid to apply pressure to at least one side of said shoulder to move said sliding piston in a desired axial direction.

7. The valve as claimed in claim 1, comprising a substantially cylindrical outer housing having two end faces, wherein a first plurality of valve components are axially stacked and attached to a first end face of said housing by a plurality of radially-spaced-apart threaded fasteners and a second plurality of valve components is axially stacked and attached to a second end face of said housing by a further plurality of threaded fasteners.

8. The valve as claimed in claim 7 wherein one of said valve components is a central seal boss.

9. The valve as claimed in claim 8 wherein said central boss is part of a disc.

10. The valve as claimed in claim 8 wherein said central seal boss is connected to said piston.

11. The valve as claimed in claim 8 wherein said central boss is connected to said inlet port.

12. The valve as claimed in claim 1, wherein all ports are active to form a three-way valve.

13. The valve as claimed in claim 12, wherein movement of the piston to be proximate to said inlet port allows fluid flow in either direction between said outlet port and said third port.

14. The valve as claimed in claim 13, wherein movement of the piston to be proximate to said outlet port causes said piston to block fluid flow through said third port.

15. (canceled)
